(19) United States
(12) Patent Application Publication
(10) Pub. No.: US 2017/0013636 A1
(43) Pub. Date: Jan. 12, 2017

(54) Reducing Interference in Multipoint Operation

(71) Applicant: Telefonaktiebolaget L M Ericsson (publ), Stockholm (SE)

(72) Inventors: Yi-Pin Eric Wang, Fremont, CA (US); Sairamesh Nammi, Stockholm (SE); Andres Reial, Malmo (SE)

(21) Appl. No.: 14/791,774

(22) Filed: Jul. 6, 2015

(51) Int. Cl. H04W 72/12; H04W 72/04; H04W 72/08

(52) U.S. Cl. CPC H04W 72/121; H04W 72/1273; H04W 72/082; H04W 72/042; H04W 88/08

(57) ABSTRACT

It is presented a method for transmitting interference cancellation information to a first user equipment, UE. The method is performed in a first network node and comprises the steps of: determining that the first UE is connected to the first network node in a multipoint fashion such that the first UE is also connected to a second network node; obtaining first downlink scheduling information describing downlink transmission from the first network node to a second UE; and transmitting interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

### TECHNICAL FIELD

The invention relates to methods, a first network node, a first user equipment, computer programs and computer program products for reducing interference in multipoint operation.

### BACKGROUND

In mobile communication systems, there are many network nodes, such as radio base stations, that are used to provide coverage to user equipments (UEs). However, the network nodes are often arranged such that the UEs experience interference from neighbouring network nodes. Such interference limits the link quality for UEs, resulting in limited spectral efficiency and throughput.

Multipoint transmission and reception refers to a system where the transmission and/or reception at multiple, geographically separated antenna sites is coordinated in order to improve system performance.

However, in a multipoint situation, a UE can also experience interference from multiple transmission points since the UE is often located in the outer regions of a cell when multipoint is used.

### SUMMARY

It is an object to reduce interference in when a UE is configured to use multipoint transmissions.

According to a first aspect, it is presented a method for transmitting interference cancellation information to a first user equipment, UE. The method is performed in a first network node and comprises the steps of: determining that the first UE is connected to the first network node in a multipoint fashion such that the first UE is also connected to a second network node; obtaining first downlink scheduling information describing downlink transmission from the first network node to a second UE; and transmitting interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

The interference cancellation information may be in the form of a scheduling signal and the indicator may be a combination of parameter values which is not used in a regular scheduling signal.

The method may further comprise the step of: refraining from scheduling downlink data for the first UE in a time period corresponding to the first downlink scheduling information.

In the step of transmitting, the first downlink scheduling information may be scrambled with a common identifier.

The method may further comprise the step of: transmitting an identifier of the second UE to the first UE. In such a case, in the step of transmitting, the first downlink scheduling information is scrambled with the identifier of the second UE.

The method may further comprise the step of: determining when a first condition is true, the first condition being that, from the first network node a signal quality of downlink transmissions to the first UE is greater than a signal quality of downlink transmissions to the second UE adjusted by an offset. In such a case, the step of transmitting interference cancellation information is only performed when the first condition is true.

According to a second aspect, it is presented a first network node for transmitting interference cancellation information to a first user equipment, UE. The first network node comprises: means for determining that the first UE is connected to the first network node in a multipoint fashion such that the first UE is also connected to a second network node; means for obtaining first downlink scheduling information describing downlink transmission from the first network node to a second UE; and means for transmitting interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

The interference cancellation information may be in the form of a scheduling signal and the indicator may be a combination of parameter values which is not used in a regular scheduling signal.

The first network node may further comprise means for refraining from scheduling downlink data for the first UE in a time period corresponding to the first downlink scheduling information.

The means for transmitting may comprise means for scrambling the first downlink scheduling information with a common identifier.

The first network node may further comprise means for transmitting an identifier of the second UE to the first UE; and wherein the means for transmitting comprises means for scrambling the first downlink scheduling information with the identifier of the second UE.

The first network node may further comprise: means for determining when a first condition is true, the first condition being that, from the first network node a signal quality of downlink transmissions to the first UE is greater than a signal quality of downlink transmissions to the second UE adjusted by an offset; and means for only transmitting interference cancellation information when the first condition is true.

The first network node may further comprise a processor; and a memory storing instructions that, when executed by the processor, causes the first network node to implement each one of the mentioned means.

According to a third aspect, it is presented a computer program for transmitting interference cancellation information to a first user equipment, UE. The computer program comprises computer program code which, when run on a first network node causes the first network node to: determine that the first UE is connected to the first network node in a multipoint fashion such that the first UE is also connected to a second network node; obtain first downlink scheduling information describing downlink transmission from the first network node to a second UE; and transmit interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

According to a fourth aspect, it is presented a computer program product comprising a computer program according to the third aspect and a computer readable means on which the computer program is stored.

According to a fifth aspect, it is presented a method for reducing interference. The method is performed in a first user equipment, UE, and comprises the steps of: determining that the first UE is connected to the first network node in a multipoint fashion such that the first UE is also connected to a second network node; receiving interference cancellation information from the first network node, over a control channel also used by the first network node to transmit scheduling information to the first UE, the interference cancellation information comprising first downlink scheduling information describing downlink transmission from the first network node to a second UE and an indicator that the interference cancellation information does not contain scheduling information for the first UE; and reducing interference by removing an estimated contribution by a downlink signal in accordance with the first downlink scheduling information.

The interference cancellation information may be in the form of a scheduling signal and the indicator may be a combination of parameter values which is not used in a regular scheduling signal.

The step of receiving may comprise descrambling the first downlink scheduling information with a common identifier.

The method may further comprise the step of: receiving an identifier of the second UE from the first network node. In such a case, the step of receiving comprises descrambling the first downlink scheduling information with the identifier of the second UE.

According to a sixth aspect, it is presented a first user equipment, UE, for reducing interference. The first UE comprises: means for determining that the first UE is connected to the first network node in a multipoint fashion such that the first UE is also connected to a second network node; means for receiving interference cancellation information from the first network node, over a control channel also used by the first network node to transmit scheduling information to the first UE, the interference cancellation information comprising first downlink scheduling information describing downlink transmission from the first network node to a second UE and an indicator that the interference cancellation information does not contain scheduling information for the first UE; and means for reducing interference by removing an estimated contribution by a downlink signal in accordance with the first downlink scheduling information.

The interference cancellation information may be in the form of a scheduling signal and the indicator may be a combination of parameter values which is not used in a regular scheduling signal.

The means for receiving may comprise means for causing the first UE to descramble the first downlink scheduling information with a common identifier.

The first UE may further comprise means for receiving an identifier of the second UE from the first network node. In such a case, the means for receiving comprises means for descrambling the first downlink scheduling information with the identifier of the second UE.

The first UE may further comprise a processor; and a memory storing instructions that, when executed by the processor, causes the first UE to implement each one of the mentioned means.

According to a seventh aspect, it is presented a computer program for reducing interference. The computer program comprises computer program code which, when run on a first user equipment, UE, causes the first UE to: determine that the first UE is connected to the first network node in a multipoint fashion such that the first UE is also connected to a second network node; receive interference cancellation information from the first network node, over a control channel also used by the first network node to transmit scheduling information to the first UE, the interference cancellation information comprising first downlink scheduling information describing downlink transmission from the first network node to a second UE and an indicator that the interference cancellation information does not contain scheduling information for the first UE; and reduce interference by removing an estimated contribution by a downlink signal in accordance with the first downlink scheduling information.

According to an eighth aspect, it is presented a computer program product comprising a computer program according to the seventh aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a mobile communication system where embodiments presented herein can be applied;

FIG. 2 is a sequence diagram illustrating communication between network nodes and UEs of FIG. 1 to enable interference reduction at the first UE;

FIGS. 3A-B are schematic diagrams illustrating embodiments of how the indicator that the interference cancellation information does not contain scheduling information can be represented in the interference cancellation information;

FIGS. 4A-B are flow charts illustrating embodiments of methods for transmitting interference cancellation information to a first user equipment;

FIGS. 5A-B are flow charts illustrating embodiments of methods for reducing interference;

FIG. 6 is a schematic diagram showing some components of the first network node of FIGS. 1 and 2 according to one embodiment;

FIG. 7 is a schematic diagram showing some components of the first UE of FIGS. 1 and 2 according to one embodiment;

FIG. 8 is a schematic diagram showing functional modules of the first network node of FIGS. 1-2 according to one embodiment;

FIG. 9 is a schematic diagram showing functional modules of the first UE of FIGS. 1-2 according to one embodiment; and

FIG. 10 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

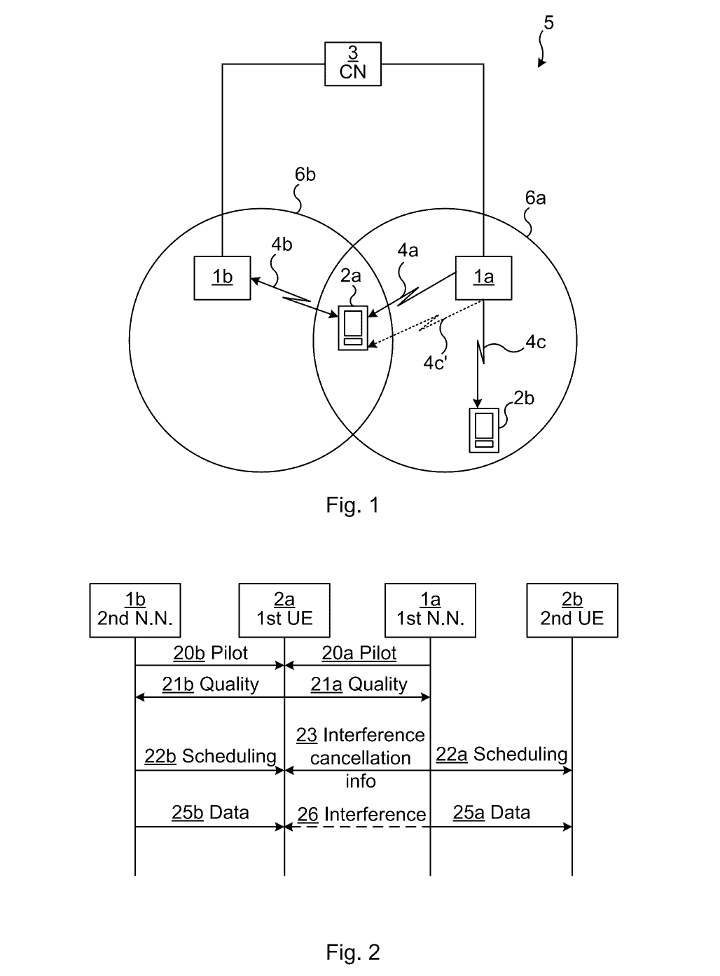

FIG. 1 is a schematic diagram illustrating a mobile communication system 5 where embodiments presented herein can be applied. The mobile communication system 5 comprises a core network 3 and one or more network nodes 1a-b, being a radio base station such as evolved Node Bs 1, also known as eNode Bs or eNBs. The network nodes 1a-b could also be in the form of Node Bs, BTSs (Base Transceiver Stations) and/or BSSs (Base Station Subsystems). Moreover, one or more of the network nodes 1a-b could be a remote radio unit under control of a radio base station. In any case, each network node 1a-b provides radio connectivity to one or more user equipments (UEs) 2a-b. The term UE is also known as mobile communication terminal, mobile terminal, mobile station, user terminal, user agent, etc.

The network nodes 1a-b are also connected to the core network 3 for connectivity to central functions and other networks. While the mobile communication system 5 of FIG. 1 shows two network nodes 1a-b, the mobile communication system 5 can have any number of network nodes and corresponding wireless radio interfaces and cells, supporting a suitable number of UEs.

The mobile communication system 5 can e.g. comply with any one or a combination of LTE (Long Term Evolution), W-CDMA (Wideband Code Division Multiple Access), EDGE (Enhanced Data Rates for GSM Evolution, GPRS (General Packet Radio Service)), CDMA2000 (Code Division Multiple Access 2000), etc., or any future mobile communication system standard, as long as the principles described hereinafter are applicable.

The communication between each UE 2a-b and the network nodes 1a-b occurs over a wireless radio interface. In this example, there is a first wireless radio interface 4a between the first UE 2a and a first network node is and a second wireless radio interface 4b between the first UE 2a and a second network node 1b. Moreover, there is a third wireless interface 4c between the second UE 2b and the first network node 1a. Each network node 1a-b provides coverage using a corresponding cell 6a-b. In this example, each network node 1a-b has a single associated cell 6a-b. However, it is to be noted that each network node can have multiple associated cells and the number of associated cells can differ between network nodes.

Multipoint transmission and reception refers to a system where the transmission and/or reception at multiple, geographically separated antenna sites is coordinated in order to improve system performance. For example, for the first UE 2a of FIG. 1, the first and second network nodes 1a-b can cooperate in such a way since the UE 2 is within the coverage of both these network nodes 1a-b.

The coordination can either be distributed, by means of direct communication between the different sites, or by means of a central coordinating node. The multipoint operation can e.g. be HSPA (High Speed Packet Access) multi-flow in W-CDMA or Co-ordinated Multi Point (CoMP) in LTE, or any other suitable multipoint operation.

However, in this example, the third wireless interface 4c from the first network node is to the second UE 2b acts as interference 4c′ to the first UE 2a.

As described in more detail below, the first network node 1a informs the first UE 2a of the details of transmissions over the third wireless interface 4c. In this way, the first UE 2a can subtract at least part of the interference 4c′ from a received signal to thereby reduce or even cancel out the interference 4c′.

It is to be noted that the first and second network nodes are called so here to define their roles in the communication in this particular instance. In another situation, the second network node can act as described for the first network node and vice versa. Analogously, it is to be noted that the first and second UEs are called so here to define their roles in the communication in this particular instance. In another situation, the second UE can act as described for the first UE and vice versa.

FIG. 2 is a sequence diagram illustrating communication between network nodes and UEs of FIG. 1 to enable interference reduction at the first UE 2a.

The first UE 2a receives a first pilot signal 20a from the first network node 1a and a second pilot signal 20b from the second network node 1b. The 1^{st} UE then sends a first quality measurement 21a to the first network node 1a and a second quality measurement 21b to the second network node, indicating the quality of the received pilot signals 20a-b.

Multipoint transmissions from the first and second network nodes 1a-b to the first UE 2a is then set up as known in the art per se.

In this scenario, the second network node 1b determines to send downlink data to the first UE 2a. In parallel, first network node 1a determines to send downlink transmission to the second UE 2b.

The first network node 1a then transmits first downlink scheduling information 22a to the second UE 2b over a control channel such as PDCCH (Physical Downlink Control Channel). The first downlink scheduling information contains parameter values to allow the second UE 2b to receive the subsequent data transmission. For instance, the first downlink scheduling information 22a can contain one or more of modulation details, number of codes, transport block size, HARQ information etc.

Analogously, the second network node 1b transmits second downlink scheduling information 22b to the first UE 2a over a control channel such as PDCCH. The second downlink scheduling information contains parameter values to allow the first UE 2a to receive the subsequent data transmission. For instance, the second downlink scheduling information 22b can contain one or more of modulation details, number of codes, transport block size, HARQ information etc.

However, according to embodiments presented herein, the first network node 1a also transmits interference cancellation information 23 to the first UE 2a over a control channel such as PDCCH. The interference cancellation information 23 contains the first downlink scheduling information 22a and an indicator that the interference cancellation information does not contain scheduling information for the first UE 2a.

The second network node 1b then transmits second data 25b to the first UE 2a. In parallel, the first network node 1a transmits first data 25a to the second UE 2b, which acts as interference 26 for the first UE 2a. However, since the first UE 2a now also has the first downlink scheduling information from the interference cancellation information 23, the first UE can decode the second data which is part of the interference 26 and remove this from the received signal.

The decoding of the downlink control channels from both network nodes occurs in the first UE 2a every TTI (Transmission Time Interval) to thereby check whether it should expect the downlink transmission from either or both network nodes. Note that in HSPA (High Speed Packet Access), the downlink scheduling information is transmitted two slots before the data traffic channel, while in LTE/LTE-A, the downlink scheduling information is transmitted in the same TTI as that of data traffic channel.

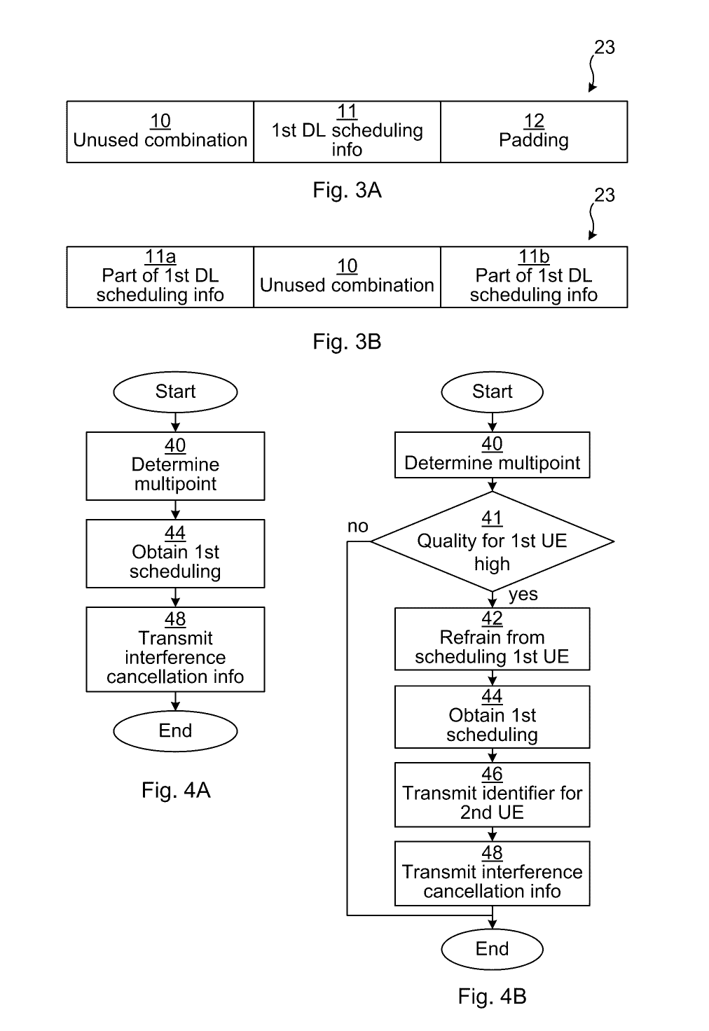

FIGS. 3A-B are schematic diagrams illustrating how the indicator that the interference cancellation information does not contain scheduling information can be represented in the interference cancellation information. The indicator is needed such that the first network node does not interpret the interference cancellation info as downlink scheduling information indicating data intended for the first UE. The indicator can then be an new combination in the control channel field to indicate that the intended control channel is carrying assistance information for facilitating the interference cancellation as shown.

In FIG. 3A, the interference cancellation information 23 comprises a new combination of parameters 10, the first downlink scheduling information ii and optionally padding 12 to make up the signal. The new combination of parameters 10 is a combination which is not used for regular scheduling and is hitherto not part of the standard. For instance, let us consider an example where the downlink control channel carriers 20 bits of information, where the first two bits indicate modulation (QPSK (Quadrature phase-shift keying), 16-QAM (Quadrature amplitude modulation), 16-QAM), the next six bits indicate the transport block size, and the remaining bits to indicate HARQ (Hybrid automatic repeat request) process number, etc.

If the two modulation bits are defined as 00-QPSK, 01-16 QAM, 10-64 QAM, then 11 is not defined. Here however, this undefined combination can be utilized as the new combination being the indicator that the interference cancellation information does not contain scheduling information. Hence, if the network sends 11 in the modulation bits, then the UE should interpret this such that the control channel is used for the interference cancellation information and not for scheduling. Similarly, if the transport block size combination is 111111, this is undefined and can be used as the new combination.

To allow the UE to decode the interference cancellation information, each new combination can be associated with a real value, e.g. 11 can indicate 16-QAM but as interference cancellation. Alternatively, the real value can be communicated in another way.

The new combination 10 is a combination of parameter values which is not used in a regular scheduling signal. In this way, the indication can be transmitted as a regular scheduling message without violating radio network standards. It is to be noted that the placement of the different parts of the interference cancellation information 23 is flexible. For instance, as shown in FIG. 3B, there is a first part of the first downlink scheduling information 11a, followed by the new combination 10 and finally a second part of the first downlink scheduling information 11b. Padding can be added if needed (not shown here).

FIGS. 4A-B are flow charts illustrating embodiments of methods for transmitting interference cancellation information to a first user equipment. The method is performed in a first network node (1a of FIG. 2).

In a determine multipoint step 40, it is determined that the first UE is connected to the first network node in a multipoint fashion such that the first UE is also connected to a second network node. In other words, this step ensures that the first UE is configured in multipoint mode.

In an obtain 1^{st} scheduling step 44, first downlink scheduling information is obtained. The first downlink scheduling information describes downlink transmission from the first network node to a second UE and corresponds to the scheduling 22a of FIG. 2.

In a transmit interference cancellation info step 48, interference cancellation information is transmitted to the first UE. The interference cancellation information is transmitted over a control channel also used by the first network node to transmit scheduling information to the first UE. The interference cancellation information (see 23 of FIG. 2) comprises the first downlink scheduling information. Moreover, the interference cancellation information comprises an indicator that the interference cancellation information does not contain scheduling information for the first UE. This is to prevent the first UE from interpreting the interference cancellation information as scheduling of downlink data for the first UE.

The interference cancellation information can be in the form of a regular scheduling signal. The indicator can then be a combination of parameter values which is not used in a regular scheduling signal, as exemplified with reference to FIGS. 3A-B above, i.e. a new combination.

In order to allow both the first UE and the second UE to decipher the first downlink scheduling information, this can be scrambled with a common identifier, e.g. a common RNTI (Radio Network Temporary Identifier). Note that in this case, the first UE needs to decode the control channel using its own H-RNTI (e.g. for the second downlink scheduling information 22b of FIG. 2) as well as the common RNTI (pre-configured) for the interference cancellation information.

Looking now to FIG. 4B, only new or modified steps compared to the method illustrated by the flow chart of FIG. 4A will be described.

In an optional conditional quality for first UE high step 41, it is determined whether a first condition is true. The first condition is that, from the first network node, a signal quality of downlink transmissions to the first UE is greater than a signal quality of downlink transmissions to the second UE adjusted by an offset. The metric used for signal quality may be a signal power, SNR, SIR, or SINR metric, expressed in dB or linear power. The offset can be positive, negative or zero (i.e. no offset). The offset can be applied using addition/subtraction or using multiplication. When the first condition is true, the method continues to an optional refrain from scheduling first UE step 42 or the obtain 1^{st} scheduling step 44 when step 42 is not performed.

The reason for sending the interference cancellation information only when the quality for the first UE is sufficiently high is that the first UE may not able to utilise the interference cancellation information from the first network node otherwise. In these cases, sending the interference cancellation information uses radio resources and processing resources for no reason, whereby it may be better to abstain.

When the first UE is in multipoint operation, the first UE sends CQI (Channel Quality Indicator) of both links to both network nodes. A UE which is not in multipoint operation sends CQI to the network node it is connected to. In this way, CQI is one example of a quality measurement that can be used in this step.

In the optional refrain from scheduling 1^{st} UE step 42, the first network node refrains from scheduling downlink data for the first UE in a time period corresponding to the first downlink scheduling information.

The quality feedbacks used in step 41 can also be used by the respective schedulers of the first network node and the second network node to coordinate their scheduling decision. For example, only when the quality condition in step 41 is true, in which case the first UE can perform interference cancellation for the data to the second UE, does the scheduler in the first network node scheduler schedule data for the second UE at the same time that the second network node schedules data to the first UE.

In an optional transmit identifier for 2^{nd} UE step 46, an identifier of the second UE is transmitted to the first UE. In such a case, in the transmit interference cancellation info step 48, the first downlink scheduling information is scrambled with the identifier of the second UE. The identifier of the second UE replaces then the scheduling format information for the second UE. The identifier of the second UE can e.g. be H-RNTI (HS-DSCH (High Speed Downlink Shared Channel) RNTI) when used in HSPA and C-RNTI (Cell Radio Network Temporary Identifier) when used in LTE.

It is to be noted that the optional steps 41, 42 and 46 do not need to be performed as part of the same method. Embodiments can use none, one, two or all three of these optional steps.

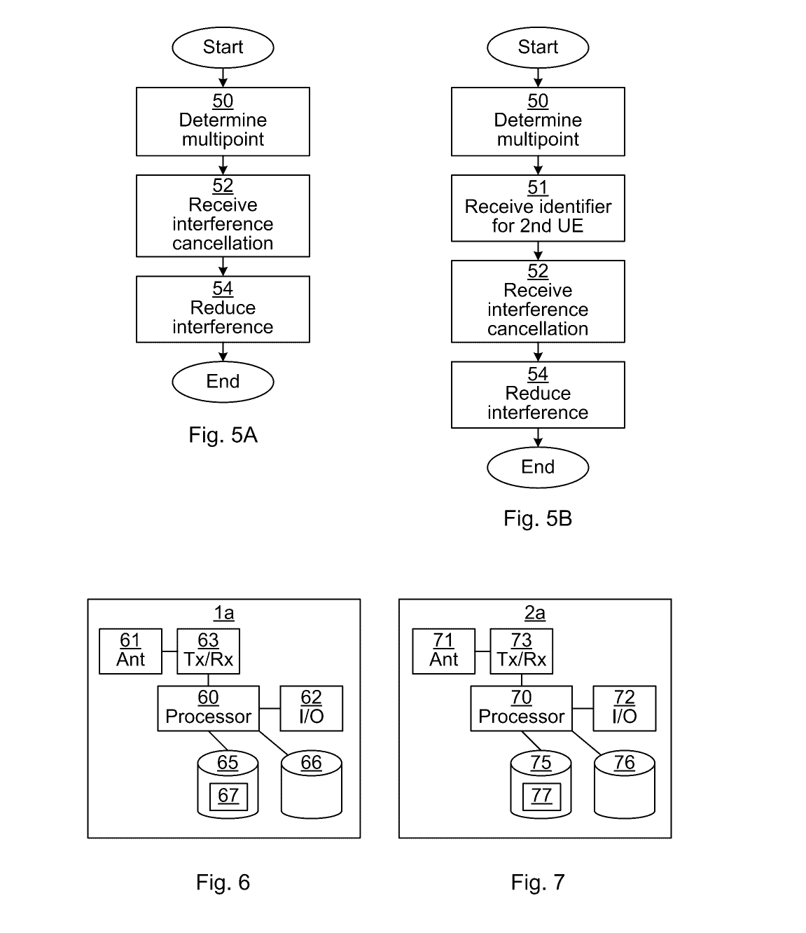

FIGS. 5A-B are flow charts illustrating embodiments of methods for reducing interference. The method is performed in a first UE (2a of FIGS. 1-2).

In a determine multipoint step 50, the UE determines that it is connected to the first network node in a multipoint fashion such that the first UE is also connected to a second network node. In other words, this step ensures that the first UE is configured in multipoint mode.

In a receive interference cancellation step 52, interference cancellation information is received from the first network node. The interference cancellation information is received over a control channel also used by the first network node to transmit scheduling information to the first UE. The interference cancellation information comprises first downlink scheduling information describing downlink transmission from the first network node to a second UE and an indicator that the interference cancellation information does not contain scheduling information for the first UE. Due to the indicator, the first UE is prevented from interpreting the interference cancellation information as scheduling information for data from the first network node to the first UE.

The interference cancellation information can thus be in the form of a scheduling signal. As explained above, the indicator can be a combination of parameter values which is not used in a regular scheduling signal.

In a reduce interference step 54, interference is reduced by removing an estimated contribution by a downlink signal in accordance with the first downlink scheduling information. While this is often referred to as interference cancellation, it is possible that some part of the downlink signal remains, whereby the cancellation is not perfect. Nevertheless the interference due to the signal to the second UE may be essentially removed.

In one embodiment, the first downlink scheduling information is scrambled with a common identifier to allow both the first UE and the second UE to descramble the first downlink scheduling information. In such a case, the first UE descrambles the first downlink scheduling information with the common identifier.

Looking now to FIG. 5B, only new or modified steps compared to the method illustrated by the flow chart of FIG. 5A will be described.

In a receive identifier for 2^{nd} UE step 51, an identifier of the second UE is received from the first network node. In such a case, the first downlink scheduling information is scrambled with the identifier of the second UE. But since the first UE now has this identifier, the first UE can descramble the first downlink scheduling information with the identifier of the second UE.

FIG. 6 is a schematic diagram showing some components of the first network node 1a of FIGS. 1 and 2. A processor 60 is provided using any combination of one or more of a suitable central processing unit (CPU), multiprocessor, microcontroller, digital signal processor (DSP), application specific integrated circuit etc., capable of executing software instructions 67 stored in a memory 65, which can thus be a computer program product. The processor 60 can be configured to execute the method described with reference to FIGS. 4A-B above.

The memory 65 can be any combination of read and write memory (RAM) and read only memory (ROM). The memory 65 also comprises persistent storage, which, for example, can be any single one or combination of magnetic memory, optical memory, solid state memory or even remotely mounted memory.

A data memory 66 is also provided for reading and/or storing data during execution of software instructions in the processor 60. The data memory 66 can be any combination of read and write memory (RAM) and read only memory (ROM).

The first network node 1a further comprises an I/O interface 62 for communicating with other external entities. Optionally, the I/O interface 62 also includes a user interface.

The first network node 1a also comprises one or more transceivers 63, comprising analogue and digital components, and a suitable number of antennas 61 for wireless communication with UEs as shown in FIG. 1.

Other components of the first network node 1a are omitted in order not to obscure the concepts presented herein.

FIG. 7 is a schematic diagram showing some components of the first UE 2a of FIGS. 1 and 2. A processor 70 is provided using any combination of one or more of a suitable central processing unit (CPU), multiprocessor, microcontroller, digital signal processor (DSP), application specific integrated circuit etc., capable of executing software instructions 77 stored in a memory 75, which can thus be a computer program product. The processor 70 can be configured to execute the method described with reference to FIGS. 5A-B above.

The memory 75 can be any combination of read and write memory (RAM) and read only memory (ROM). The memory 75 also comprises persistent storage, which, for example, can be any single one or combination of magnetic memory, optical memory, solid state memory or even remotely mounted memory.

A data memory 76 is also provided for reading and/or storing data during execution of software instructions in the processor 70. The data memory 76 can be any combination of read and write memory (RAM) and read only memory (ROM).

The first UE 2a further comprises an I/O interface 72 for communicating with other external entities. Optionally, the I/O interface 72 also includes a user interface.

The first UE 2a also comprises one or more transceivers 73, comprising analogue and digital components, and a suitable number of antennas 71 for wireless communication with network nodes as shown in FIG. 1.

Other components of the first UE 2a are omitted in order not to obscure the concepts presented herein.

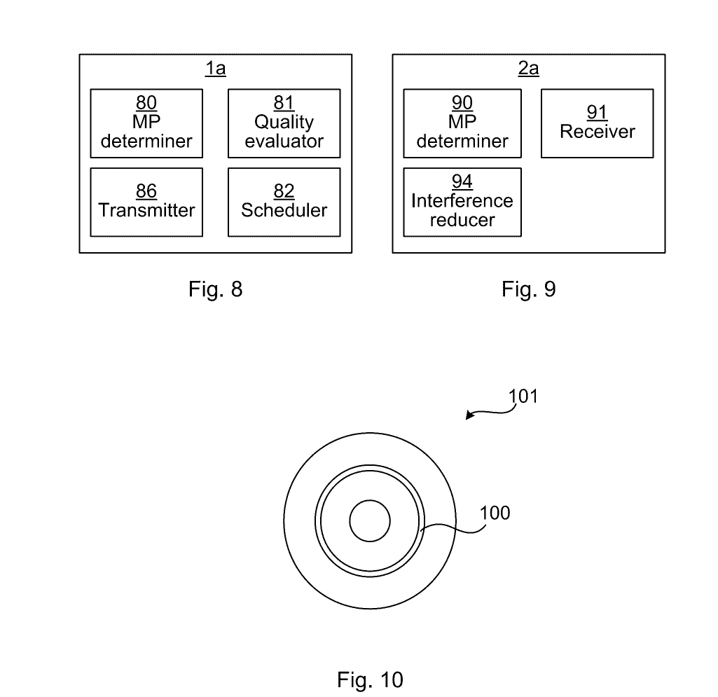

FIG. 8 is a schematic diagram showing functional modules of the first network node is of FIGS. 1-2 according to one embodiment. The modules can be implemented as software instructions (67 of FIG. 6) such as a computer program executing in the first network node 1a. Alternatively, part or all of the modules are implemented using hardware such as using one or more Application Specific Integrated Circuits (ASICs), Field Programmable Gate Array (FPGA) and/or discrete hardware components. In any case, the modules correspond to the steps in the methods illustrated in FIGS. 4A-B and described above.

An MP determiner 80 corresponds to step 40. A quality evaluator 81 corresponds to step 41. A transmitter 86 corresponds to steps 46 and 48. A scheduler 82 corresponds to steps 42 and 44.

FIG. 9 is a schematic diagram showing functional modules of the first UE 2a of FIGS. 1-2 according to one embodiment. The modules can be implemented as software instructions (77 of FIG. 7) such as a computer program executing in the first UE 2a. Alternatively, part or all of the modules are implemented using hardware such as using one or more Application Specific Integrated Circuits (ASICs), Field Programmable Gate Array (FPGA) and/or discrete hardware components. In any case, the modules correspond to the steps in the methods illustrated in FIGS. 5A-B and described above.

An MP determiner 90 corresponds to step 50. A receiver 91 corresponds to steps 51 and 52. An interference reducer 94 corresponds to step 54.

FIG. 10 shows one example of a computer program product 101 comprising computer readable means. On this computer readable means a computer program 100 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 65 of FIG. 6 or the computer program product 75 of FIG. 7. While the computer program mo is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1-26. (canceled)

27. A method for transmitting interference cancellation information to a first user equipment, UE, the method being performed in a first network node and comprising the steps of:
determining that the first UE is connected to the first network node in a multipoint fashion such that the first UE is also connected to a second network node;
obtaining first downlink scheduling information describing downlink transmission from the first network node to a second UE; and
transmitting interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

28. The method according to claim 27, wherein the interference cancellation information is in the form of a scheduling signal and wherein the indicator is a combination of parameter values which is not used in a scheduling signal used for scheduling.

29. The method according to claim 27, further comprising the step of:
refraining from scheduling downlink data for the first UE in a time period corresponding to the first downlink scheduling information.

30. The method according to claim 27, wherein in the step of transmitting, the first downlink scheduling information is scrambled with a common identifier.

31. The method according to claim 27, further comprising the step of:
transmitting an identifier of the second UE to the first UE; and
wherein in the step of transmitting, the first downlink scheduling information is scrambled with the identifier of the second UE.

32. The method according to claim 27, further comprising the step of:
determining when a first condition is true, the first condition being that, from the first network node a signal quality of downlink transmissions to the first UE is greater than a signal quality of downlink transmissions to the second UE adjusted by an offset; and
wherein the step of transmitting interference cancellation information is only performed when the first condition is true.

33. A first network node for transmitting interference cancellation information to a first user equipment, UE, the first network node comprising:
a processor; and
a memory storing instructions that, when executed by the processor, causes the first network node to:
determine that the first UE is connected to the first network node in a multipoint fashion such that the first UE is also connected to a second network node;
obtain first downlink scheduling information describing downlink transmission from the first network node to a second UE; and
transmit interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

34. The first network node according to claim 33, wherein the interference cancellation information is in the form of a scheduling signal and wherein the indicator is a combination of parameter values which is not used in a scheduling signal used for scheduling.

35. The first network node according to claim 33, wherein the instructions, when executed by the processor, further cause the first network node to refrain from scheduling downlink data for the first UE in a time period corresponding to the first downlink scheduling information.

36. The first network node according to claim 33, wherein the instructions, when executed by the processor, cause the first network node to scramble the first downlink scheduling information with a common identifier.

37. The first network node according to claim 33, wherein the instructions, when executed by the processor, further cause the first network node to transmit an identifier of the second UE to the first UE, and to scramble the first downlink scheduling information with the identifier of the second UE.

38. The first network node according to claim 33, wherein the instructions, when executed by the processor, further cause the first network node to:
determine when a first condition is true, the first condition being that, from the first network node a signal quality of downlink transmissions to the first UE is greater than a signal quality of downlink transmissions to the second UE adjusted by an offset; and
only transmit interference cancellation information when the first condition is true.

39. A computer program product for transmitting interference cancellation information to a first user equipment, UE, the computer program product stored on a non-transitory computer readable medium and comprising computer program code which, when run on a first network node causes the first network node to:
determine that the first UE is connected to the first network node in a multipoint fashion such that the first UE is also connected to a second network node;
obtain first downlink scheduling information describing downlink transmission from the first network node to a second UE; and
transmit interference cancellation information to the first UE over a control channel also used by the first network node to transmit scheduling information to the first UE, the interference cancellation information comprising the first downlink scheduling information and an indicator that the interference cancellation information does not contain scheduling information for the first UE.

40. A method for reducing interference, the method being performed in a first user equipment, UE, and comprising the steps of:
determining that the first UE is connected to the first network node in a multipoint fashion such that the first UE is also connected to a second network node;
receiving interference cancellation information from the first network node, over a control channel also used by the first network node to transmit scheduling information to the first UE, the interference cancellation information comprising first downlink scheduling information describing downlink transmission from the first network node to a second UE and an indicator that the interference cancellation information does not contain scheduling information for the first UE; and
reducing interference by removing an estimated contribution by a downlink signal in accordance with the first downlink scheduling information.

41. The method according to claim 40, wherein the interference cancellation information is in the form of a scheduling signal and wherein the indicator is a combination of parameter values which is not used in a scheduling signal used for scheduling.

42. The method according to claim 40, wherein the step of receiving comprises descrambling the first downlink scheduling information with a common identifier.

43. The method according to claim 40, further comprising the step of:
receiving an identifier of the second UE from the first network node; and
wherein the step of receiving comprises descrambling the first downlink scheduling information with the identifier of the second UE.

44. A first user equipment, UE, for reducing interference, the first UE comprising:
a processor; and
a memory storing instructions that, when executed by the processor, causes the first UE to:
determine that the first UE is connected to the first network node in a multipoint fashion such that the first UE is also connected to a second network node;
receive interference cancellation information from the first network node, over a control channel also used by the first network node to transmit scheduling information to the first UE, the interference cancellation information comprising first downlink scheduling information describing downlink transmission from the first network node to a second UE and an indicator that the interference cancellation information does not contain scheduling information for the first UE; and
reduce interference by removing an estimated contribution by a downlink signal in accordance with the first downlink scheduling information.

45. The first UE according to claim 44, wherein the interference cancellation information is in the form of a scheduling signal and wherein the indicator is a combination of parameter values which is not used in a scheduling signal used for scheduling.

46. The first UE according to claim 44, wherein the instructions, when executed by the processor, further cause the first UE to descramble the first downlink scheduling information with a common identifier.

47. The first UE according to claim 44, wherein the instructions, when executed by the processor, further cause the first UE to receive an identifier of the second UE from the first network node, and to descramble the first downlink scheduling information with the identifier of the second UE.

48. A computer program product stored on a non-transitory computer readable medium and comprising computer program code which, when run on a first user equipment, UE, causes the first UE to:
determine that the first UE is connected to the first network node in a multipoint fashion such that the first UE is also connected to a second network node;
receive interference cancellation information from the first network node, over a control channel also used by the first network node to transmit scheduling information to the first UE, the interference cancellation information comprising first downlink scheduling information describing downlink transmission from the first network node to a second UE and an indicator that the interference cancellation information does not contain scheduling information for the first UE; and
reduce interference by removing an estimated contribution by a downlink signal in accordance with the first downlink scheduling information.

49. The method according to claim 27, further comprising determining whether to transmit scheduling information describing downlink transmission from the first network node to the first UE, or to transmit the interference cancellation information describing downlink transmission from the first network node to the second UE, in a transmission time interval of the control channel, and wherein said transmitting comprises transmitting the interference cancellation information in the transmission time interval of the control channel responsive to determining to transmit the interference cancellation information.

50. The method according to claim 27, wherein the first UE is configured to respectively receive scheduling information from the first and second network nodes over first and second control channels describing downlink transmission from the first and second network nodes to the first UE.

51. The method according to claim 27, further comprising scheduling a downlink transmission from the first network node to the first UE independently of the second network node scheduling a downlink transmission from the second network node to the first UE.

52. The method according to claim 28, wherein the transmitted interference cancellation information to the first UE is a downlink scheduling signal for the second UE modified to include the indicator indicating the transmitted interference cancellation information is not a scheduling signal for the first UE.
